(19) United States
(12) Patent Application Publication
(10) Pub. No.: US 2026/0274644 A1
(43) Pub. Date: Sep. 17, 2026

(54) AMMONIA SUPPLY DEVICE AND AMMONIA SUPPLY METHOD

(71) Applicant: IHI Corporation, Tokyo (JP)

(72) Inventor: Ryota SAKISAKA, Tokyo (JP)

(73) Assignee: IHI Corporation, Tokyo (JP)

(21) Appl. No.: 19/674,314

(22) Filed: May 12, 2026

Related U.S. Application Data
(63) Continuation of application No. PCT/JP2024/044691, filed on Dec. 18, 2024.

(30) Foreign Application Priority Data
Jan. 31, 2024 (JP) 2024-013213

(51) Int. Cl. B67D 7/04; B67D 7/32

(52) U.S. Cl. CPC B67D 7/04; B67D 7/3209

(57) ABSTRACT

Provided is an ammonia supply device, including: an ammonia supply system; a coupling including: a tube body having: a first opening connected to the ammonia supply system; and a second opening that is mountable to and detachable from an ammonia consumption device; a water supply port formed between the first opening and the second opening in the tube body, and connected to a water supply source (water tank); and a drain port formed between the first opening and the second opening in the tube body; and an on-off valve that opens and closes the first opening.

### CROSS REFERENCE TO RELATED APPLICATIONS

This application is a continuation application of International Application No. PCT/JP2024/044691, filed on Dec. 18, 2024, which claims priority to Japanese Patent Application No. 2024-13213 filed on Jan. 31, 2024, the entire contents of which are incorporated by reference herein.

### BACKGROUND ART

### Technical Field

The present disclosure relates to an ammonia supply device and an ammonia supply method. This application claims the benefit of priority to Japanese Patent Application No. 2024-13213 filed on Jan. 31, 2024, and contents thereof are incorporated herein.

### Related Art

Ammonia is expected to be a fuel that contributes to taking countermeasures against global warming because ammonia does not emit carbon dioxide when being burned. Accordingly, the use of ammonia as a fuel for a moving object such as a ship or a vehicle is being considered (for example, Patent Literature 1).

### CITATION LIST

### Patent Literature

[Patent Literature 1] WO 2022/045184 A1

### SUMMARY

### Technical Problem

When ammonia is used as a fuel for a moving object as disclosed in Patent Literature 1 above, it is appropriate to supply ammonia to a fuel tank of the moving object. Accordingly, it is conceivable to set up, instead of a related-art gas station, an ammonia station provided with an ammonia supply source and a dispenser connected to the ammonia supply source. At the ammonia station, after the dispenser is mounted to the fuel tank of the moving object, ammonia is supplied from the ammonia supply source to the fuel tank. When the supply is finished, the dispenser is detached from the fuel tank of the moving object.

However, if ammonia leaks from the dispenser to the atmosphere when the dispenser is detached from the fuel tank of the moving object, the external environment may be adversely affected. Accordingly, there has been a demand for development of technology to prevent the leakage of ammonia from the dispenser to the atmosphere.

In view of such problems, the present disclosure has an object to provide an ammonia supply device capable of preventing leakage of ammonia to the atmosphere, and an ammonia supply method.

### Solution to Problem

In order to solve the problems described above, according to one aspect of the present disclosure, there is provided an ammonia supply device, including: an ammonia supply source; a coupling including: a tube body having: a first opening connected to the ammonia supply source; and a second opening that is mountable to and detachable from an ammonia consumption device; a water supply port formed between the first opening and the second opening in the tube body, and connected to a water supply source; and a drain port formed between the first opening and the second opening in the tube body; and an on-off valve that opens and closes the first opening.

Further, the water supply port may be connected to an inert gas supply source in addition to the water supply source.

Further, the drain port may be located vertically below the water supply port under a state in which the second opening is mounted to the ammonia consumption device.

Further, a drain tank that stores water discharged from the tube body through the drain port may be connected to the drain port.

In order to solve the problems described above, according to one aspect of the present disclosure, there is provided an ammonia supply method, including: mounting a coupling, which includes: a tube body having a first opening connected to an ammonia supply source, and having a second opening; a water supply port formed between the first opening and the second opening in the tube body, and connected to a water supply source; and a drain port formed between the first opening and the second opening in the tube body, so as to mount the second opening of the coupling to an ammonia consumption device; supplying ammonia from the ammonia supply source to the ammonia consumption device through the coupling under a state in which the coupling is mounted to the ammonia consumption device; closing an on-off valve that opens and closes the first opening after the supply of ammonia; closing an on-off valve that opens and closes the second opening after the supply of ammonia; supplying water to the tube body through the water supply port, and discharging water from the tube body through the drain port, under a state in which the on-off valve that opens and closes the first opening and the on-off valve that opens and closes the second opening are closed; and detaching the second opening from the ammonia consumption device after the discharge of water.

Further, the ammonia supply method may further include measuring a concentration of ammonia contained in the water discharged from the tube body through the drain port, and the supply of water may be stopped when the concentration of the ammonia becomes lower than a predetermined value.

### Effects

According to the present disclosure, it is possible to prevent leakage of ammonia to the atmosphere.

### BRIEF DESCRIPTION OF DRAWINGS

FIG. 1 is an explanatory view for illustrating an example of an ammonia supply device according to a first embodiment.

FIG. 2 is an explanatory view for illustrating an example of a coupling in the first embodiment.

FIG. 3 is a flowchart for illustrating a process flow of an ammonia supply method according to the first embodiment.

FIG. 4 is an explanatory view for illustrating an example of an ammonia supply device according to a second embodiment.

FIG. 5 is a flowchart for illustrating a process flow of an ammonia supply method according to the second embodiment.

FIG. 6 is an explanatory view for illustrating an example of an ammonia supply device according to a third embodiment.

### DESCRIPTION OF EMBODIMENTS

Now, with reference to the attached drawings, embodiments of the present disclosure are described in detail. The dimensions, materials, and other specific numerical values represented in the embodiments are merely examples used for facilitating the understanding of the disclosure, and do not limit the present disclosure unless otherwise particularly noted. Elements having substantially the same functions and configurations herein and in the drawings are denoted by the same reference symbols to omit redundant description thereof. Further, illustration of elements with no direct relationship to the present disclosure is omitted.

### First Embodiment: Ammonia Supply Device 100

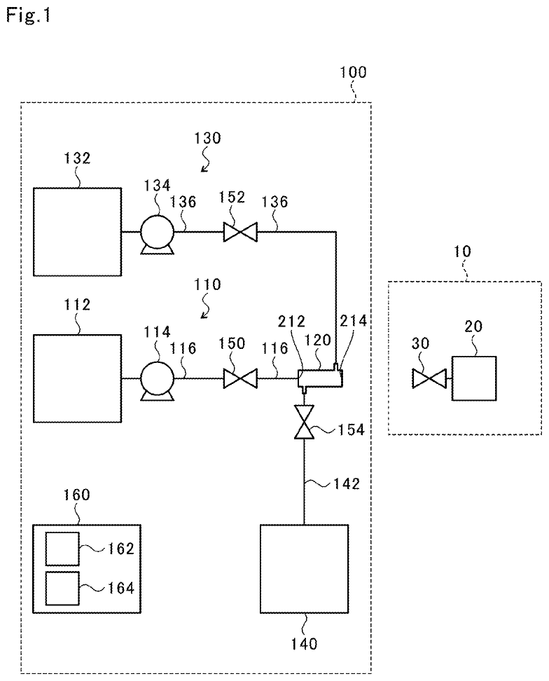

FIG. 1 is an explanatory view for illustrating an example of an ammonia supply device 100 according to a first embodiment. The ammonia supply device 100 supplies ammonia to an ammonia consumption device 10. In this embodiment, the ammonia supply device 100 supplies ammonia to a fuel tank 20 installed on the ammonia consumption device 10. The ammonia consumption device 10 is, for example, a moving object such as a ship, a vehicle, or an aircraft. The ammonia supply device 100 is set up at, for example, an ammonia station.

As illustrated in FIG. 1, the ammonia supply device 100 according to the first embodiment includes an ammonia supply system 110, a coupling 120, a water supply system 130, a drain tank 140, a first on-off valve 150, a second on-off valve 152, a third on-off valve 154, and a controller 160.

The ammonia supply system 110 includes, for example, an ammonia tank 112, a pump 114, and an ammonia supply pipe 116. The ammonia tank 112 functions as an ammonia supply source. The ammonia tank 112 stores any one or both of liquid ammonia and gaseous ammonia. A suction side of the pump 114 is connected to the ammonia tank 112. A discharge side of the pump 114 is connected to the ammonia supply pipe 116. The pump 114 sucks ammonia stored in the ammonia tank 112, and discharges the ammonia into the ammonia supply pipe 116. A first opening 212 of the coupling 120, which is described later, is connected to the ammonia supply pipe 116. The ammonia supply pipe 116 is, for example, a flexible hose.

The coupling 120 is connected to an end of the ammonia supply pipe 116. The coupling 120 is mountable to and detachable from the fuel tank 20 of the ammonia consumption device 10.

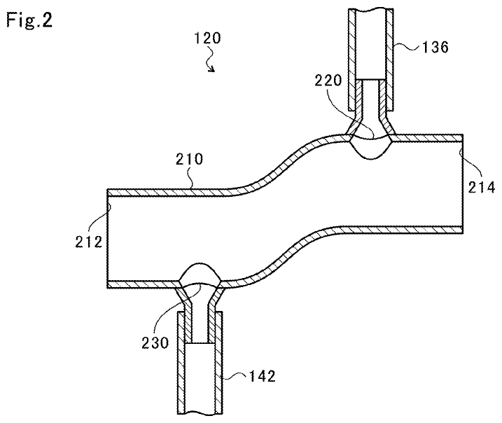

FIG. 2 is an explanatory view for illustrating an example of the coupling 120 in the first embodiment. As illustrated in FIG. 2, the coupling 120 includes a tube body 210, a water supply port 220, and a drain port 230. The first opening 212 is formed in one end portion of the tube body 210, and a second opening 214 is formed in another end portion of the tube body 210.

The first opening 212 is connected to the ammonia supply pipe 116 of the ammonia supply system 110. The first opening 212 is fixed to the ammonia supply pipe 116 by, for example, a flange.

The second opening 214 is detachably connected to the fuel tank 20 of the ammonia consumption device 10. The second opening 214 is freely detachably connected to the fuel tank 20 by, for example, a coupler.

The water supply port 220 is formed between the first opening 212 and the second opening 214 in the tube body 210. In this embodiment, the water supply port 220 is formed on the second opening 214 side in the tube body 210. The water supply system 130, which is described later, is connected to the water supply port 220. In this embodiment, a water supply pipe 136 of the water supply system 130 is connected to the water supply port 220.

The drain port 230 is formed between the first opening 212 and the second opening 214 in the tube body 210. In this embodiment, the drain port 230 is formed on the first opening 212 side in the tube body 210. Further, the drain port 230 and the water supply port 220 are formed in the tube body 210 at vertically different positions. Specifically, the water supply port 220 and the drain port 230 are formed in the tube body 210 so that the drain port 230 is located vertically below the water supply port 220 under a state in which the second opening 214 is mounted to the ammonia consumption device 10.

Further, in this embodiment, the tube body 210 may be bent, and a bottom surface in the tube body 210 may be inclined from the second opening 214 side toward the first opening 212 side under a state in which the second opening 214 is mounted to the ammonia consumption device 10.

The drain tank 140 is connected to the drain port 230 through a drain pipe 142 that is described later.

Returning to FIG. 1, the water supply system 130 includes, for example, a water tank 132, a pump 134, and the water supply pipe 136. The water tank 132 functions as a water supply source. The water tank 132 stores liquid water. A suction side of the pump 134 is connected to the water tank 132. A discharge side of the pump 134 is connected to the water supply pipe 136. The pump 134 sucks water stored in the water tank 132, and discharges the water into the water supply pipe 136. As described above, the water supply port 220 of the coupling 120 is connected to the water supply pipe 136. The water supply pipe 136 is, for example, a flexible hose.

The drain tank 140 stores the water discharged from the tube body 210 through the drain port 230 of the coupling 120. The drain pipe 142 connects the drain port 230 of the coupling 120 to the drain tank 140. The drain pipe 142 is, for example, a flexible hose.

The first on-off valve 150 is provided in the ammonia supply pipe 116. The first on-off valve 150 opens and closes the first opening 212 of the coupling 120 by opening and closing a flow passage formed in the ammonia supply pipe 116.

The second on-off valve 152 is provided in the water supply pipe 136. The second on-off valve 152 opens and closes a flow passage formed in the water supply pipe 136.

The third on-off valve 154 is provided in the drain pipe 142. The third on-off valve 154 opens and closes a flow passage formed in the drain pipe 142.

The controller 160 includes one or a plurality of processors 162, and one or a plurality of memories 164 connected to the processor 162. The processor 162 includes, for example, a central processing unit (CPU). The memory 164 includes, for example, a read only memory (ROM), and a random access memory (RAM). The ROM is a storage element which stores programs, operation parameters, and the like used by the CPU. The RAM is a storage element which temporarily stores data such as variables and parameters used for processing executed by the CPU. The controller 160 manages and controls the entire ammonia supply device 100 in cooperation with the RAM as a work area and other electronic circuits.

In this embodiment, the controller 160 controls operations of the pump 114 and the pump 134. Further, the controller 160 opens and closes the first on-off valve 150, the second on-off valve 152, and the third on-off valve 154.

### Ammonia Supply Method

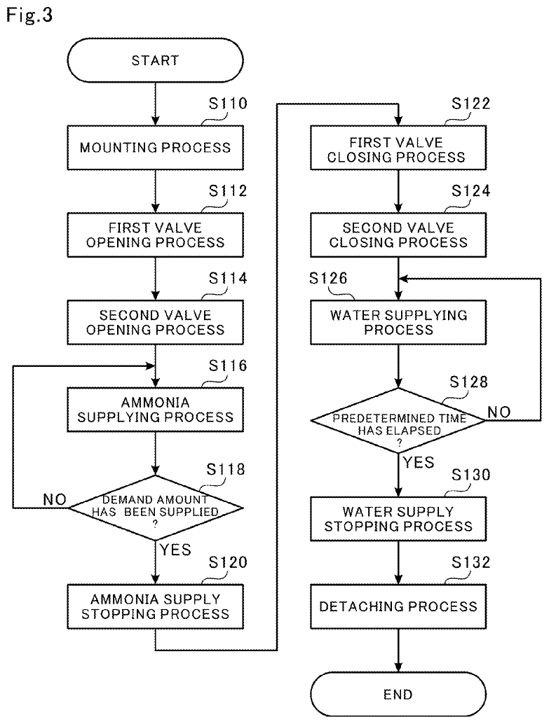

Next, an ammonia supply method of supplying ammonia to the ammonia consumption device 10 by using the above-mentioned ammonia supply device 100 is described. FIG. 3 is a flowchart for illustrating a process flow of the ammonia supply method according to the first embodiment.

As illustrated in FIG. 3, the ammonia supply method according to the first embodiment includes a mounting process S110, a first valve opening process S112, a second valve opening process S114, an ammonia supplying process S116, a demand amount determining process S118, an ammonia supply stopping process S120, a first valve closing process S122, a second valve closing process S124, a water supplying process S126, an elapsed time determining process S128, a water supply stopping process S130, and a detaching process S132. Each process is described below.

### Mounting Process S110

In the mounting process S110, the second opening 214 of the coupling 120 is mounted to the ammonia consumption device 10. In this embodiment, the second opening 214 of the coupling 120 is mounted to an on-off valve 30 provided to a supply port of the fuel tank 20 installed on the ammonia consumption device 10. The on-off valve 30 opens and closes the second opening 214 of the coupling 120.

### First Valve Opening Process S112

In the first valve opening process S112, the controller 160 opens the first on-off valve 150 that opens and closes the first opening 212 of the coupling 120.

### Second Valve Opening Process S114

In the second valve opening process S114, the controller 160 opens the on-off valve 30 that opens and closes the second opening 214 of the coupling 120.

### Ammonia Supplying Process S116

In the ammonia supplying process S116, ammonia is supplied from the ammonia supply system 110 to the ammonia consumption device 10 through the coupling 120 under a state in which the coupling 120 is mounted to the ammonia consumption device 10. In the ammonia supplying process S116 in this embodiment, the controller 160 operates the pump 114. Thus, ammonia stored in the ammonia tank 112 is supplied into the fuel tank 20 of the ammonia consumption device 10 through the ammonia supply pipe 116 and the coupling 120.

### Demand Amount Determining Process S118

In the demand amount determining process S118, the controller 160 determines whether or not a demand amount of ammonia has been supplied to the ammonia consumption device 10. As a result, when it is determined that the demand amount of ammonia has not been supplied (NO in S118), the controller 160 returns the process to the ammonia supplying process S116. Meanwhile, when it is determined that the demand amount of ammonia has been supplied (YES in S118), the controller 160 transfers the process to the ammonia supply stopping process S120.

### Ammonia Supply Stopping Process S120

In the ammonia supply stopping process S120, the controller 160 stops the supply of ammonia. In the ammonia supply stopping process S120 in this embodiment, the controller 160 stops the pump 114.

### First Valve Closing Process S122

In the first valve closing process S122, the controller 160 closes the first on-off valve 150 that opens and closes the first opening 212 of the coupling 120 after the supply of ammonia.

### Second Valve Closing Process S124

In the second valve closing process S124, the controller 160 closes the on-off valve 30 that opens and closes the second opening 214 of the coupling 120 after the supply of ammonia.

### Water Supplying Process S126

In the water supplying process S126, the controller 160 supplies water to the tube body 210 through the water supply port 220 of the coupling 120, and discharges water from the tube body 210 through the drain port 230 of the coupling 120, under a state in which the first on-off valve 150 and the on-off valve 30 are closed. In the water supplying process S126 in this embodiment, the controller 160 opens the second on-off valve 152 and the third on-off valve 154, and operates the pump 134. Thus, water stored in the water tank 132 is supplied to the tube body 210 through the water supply pipe 136 and the water supply port 220 of the coupling 120. For example, water is sprayed into the tube body 210 through the water supply port 220 by the water supply system 130. The water is then discharged from the tube body 210 through the drain port 230 of the coupling 120 and discharged into the drain tank 140 through the drain pipe 142.

### Elapsed Time Determining Process S128

In the elapsed time determining process S128, the controller 160 determines whether or not a predetermined time has elapsed from the start of the water supplying process S126. The predetermined time is, for example, the time required for a concentration of ammonia contained in the water discharged from the drain port 230 of the coupling 120 to fall below a discharge standard value after the start of the water supplying process S126. As a result, when it is determined that the predetermined time has not elapsed (NO in S128), the controller 160 returns the process to the water supplying process S126. Meanwhile, when it is determined that the predetermined time has elapsed (YES in S128), the controller 160 transfers the process to the water supply stopping process S130.

### Water Supply Stopping Process S130

In the water supply stopping process S130, the controller 160 stops the supply of water. In the water supply stopping process S130 in this embodiment, the controller 160 stops the pump 134, and closes the second on-off valve 152 and the third on-off valve 154.

### Detaching Process S132

In the detaching process S132, the second opening 214 of the coupling 120 is detached from the ammonia consumption device 10 after water is discharged.

As described above, the ammonia supply device 100 according to the first embodiment includes: the ammonia supply system 110; the coupling 120 including the tube body 210 having the first opening 212 connected to the ammonia supply system 110, and having the second opening 214 that is mountable to and detachable from the ammonia consumption device 10, the water supply port 220 formed between the first opening 212 and the second opening 214 in the tube body 210 and connected to the water supply system 130, and the drain port 230 formed between the first opening 212 and the second opening 214 in the tube body 210; and the on-off valve (first on-off valve 150) that opens and closes the first opening 212. Thus, the ammonia supply device 100 according to the first embodiment can wash the inside of the tube body 210 of the coupling 120 with water under a state in which the coupling 120 is mounted to the ammonia consumption device 10 before the coupling 120 is detached from the ammonia consumption device 10. Accordingly, the ammonia supply device 100 according to the first embodiment can flush away ammonia remaining in the tube body 210 of the coupling 120 with water after the supply of ammonia from the ammonia supply system 110 to the ammonia consumption device 10 through the coupling 120 is finished, and before the coupling 120 is detached from the ammonia consumption device 10. Accordingly, the ammonia supply device 100 according to the first embodiment can prevent leakage of ammonia to the atmosphere even when the coupling 120 is detached from the ammonia consumption device 10 after the supply of ammonia is finished.

Further, as described above, under a state in which the second opening 214 of the coupling 120 is mounted to the ammonia consumption device 10, the drain port 230 may be located vertically below the water supply port 220. With this configuration, the ammonia supply device 100 according to the first embodiment can lead the water in the tube body 210 of the coupling 120 to the drain port 230 owing to an own weight of the water. Thus, the ammonia supply device 100 according to the first embodiment can remove water from the tube body 210 of the coupling 120 even without including a dedicated device for discharging the water in the tube body 210 of the coupling 120. Accordingly, the ammonia supply device 100 according to the first embodiment can avoid a situation in which water is mixed with ammonia when ammonia is supplied to the ammonia consumption device 10 next time.

Further, as described above, the tube body 210 of the coupling 120 may be bent, and the bottom surface in the tube body 210 may be inclined from the second opening 214 side toward the first opening 212 side under a state in which the second opening 214 is mounted to the ammonia consumption device 10. With this configuration, the ammonia supply device 100 according to the first embodiment can efficiently lead the water in the tube body 210 of the coupling 120 to the drain port 230.

Further, as described above, the drain tank 140 that stores the water discharged from the tube body 210 through the drain port 230 may be connected to the drain port 230 of the coupling 120. With this configuration, the ammonia supply device 100 according to the first embodiment can avoid a situation in which the water discharged from the tube body 210, that is, the water in which ammonia is dissolved, leaks out to the outside. The wastewater stored in the drain tank 140 is subjected to ammonia removing treatment and then discharged.

### Second Embodiment: Ammonia Supply Device 300

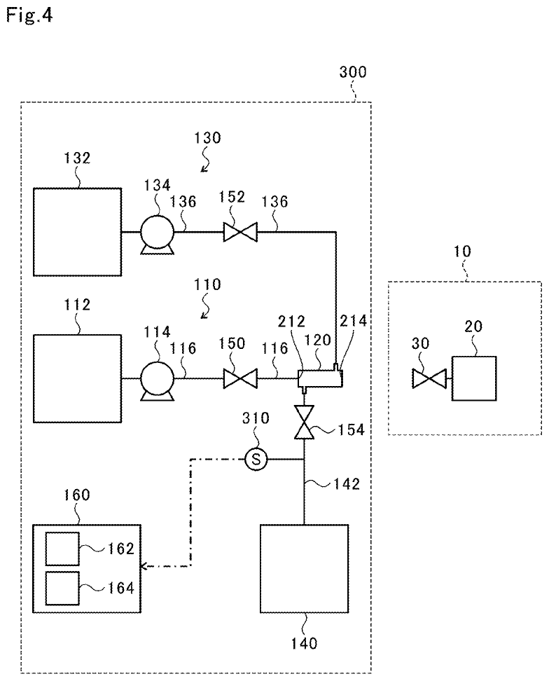

FIG. 4 is an explanatory view for illustrating an example of an ammonia supply device 300 according to a second embodiment. As illustrated in FIG. 4, the ammonia supply device 300 according to the second embodiment includes an ammonia supply system 110, a coupling 120, a water supply system 130, a drain tank 140, a first on-off valve 150, a second on-off valve 152, a third on-off valve 154, a controller 160, and a concentration sensor 310. Components that are substantially equivalent to those of the ammonia supply device 100 described above are denoted by the same reference symbols, and description thereof is omitted.

The concentration sensor 310 measures a concentration of ammonia contained in the water discharged from the tube body 210 through the drain port 230. The concentration sensor 310 is, for example, a pH sensor that measures pH. As the concentration sensor 310, a device other than a pH sensor may be used as long as the device can measure the concentration of ammonia.

Further, in this embodiment, the controller 160 acquires a measured value of the concentration sensor 310.

### Ammonia Supply Method

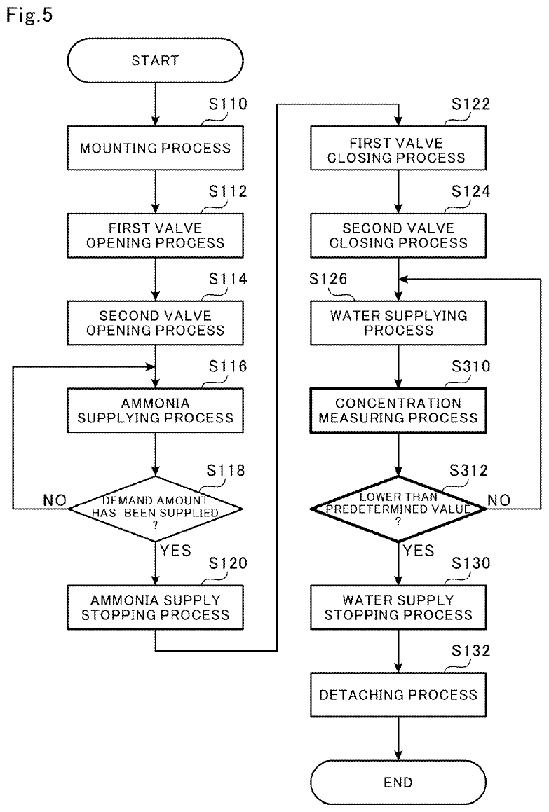

Next, an ammonia supply method of supplying ammonia to the ammonia consumption device 10 by using the above-mentioned ammonia supply device 300 is described. FIG. 5 is a flowchart for illustrating a process flow of the ammonia supply method according to the second embodiment.

As illustrated in FIG. 5, the ammonia supply method according to the second embodiment includes a mounting process S110, a first valve opening process S112, a second valve opening process S114, an ammonia supplying process S116, a demand amount determining process S118, an ammonia supply stopping process S120, a first valve closing process S122, a second valve closing process S124, a water supplying process S126, a concentration measuring process S310, a concentration determining process S312, a water supply stopping process S130, and a detaching process S132. Processes that are substantially equivalent to those of the ammonia supply method using the ammonia supply device 100 described above are denoted by the same reference symbols, and description thereof is omitted.

### Concentration Measuring Process S310

The concentration measuring process S310 is performed after the water supplying process S126. In the concentration measuring process S310, the concentration sensor 310 measures the concentration of ammonia contained in the water discharged from the tube body 210 through the drain port 230 of the coupling 120.

### Concentration Determining Process S312

In the concentration determining process S312, determination is made on whether or not the concentration of ammonia measured in the concentration measuring process S310 is lower than a predetermined value. The predetermined value is, for example, a discharge standard value of ammonia. As a result, when it is determined that the concentration of ammonia is not lower than the predetermined value, that is, is equal to or higher than the predetermined value (NO in S312), the controller 160 returns the process to the water supplying process S126. Meanwhile, when it is determined that the concentration of ammonia is lower than the predetermined value (YES in S312), the controller 160 transfers the process to the water supply stopping process S130.

As described above, the ammonia supply device 300 according to the second embodiment includes the concentration sensor 310 that measures the concentration of ammonia contained in the water discharged from the tube body 210 through the drain port 230 of the coupling 120, and when the concentration of ammonia becomes lower than the predetermined value, the supply of water to the water supply port 220 of the coupling 120 is stopped. Thus, the ammonia supply device 300 according to the second embodiment can set the concentration of ammonia remaining in the tube body 210 of the coupling 120 lower than the predetermined value after the supply of ammonia from the ammonia supply system 110 to the ammonia consumption device 10 through the coupling 120 is finished. Accordingly, the ammonia supply device 300 according to the second embodiment can further prevent leakage of ammonia to the atmosphere even when the coupling 120 is detached from the ammonia consumption device 10 after the supply of ammonia is finished.

### Third Embodiment: Ammonia Supply Device 400

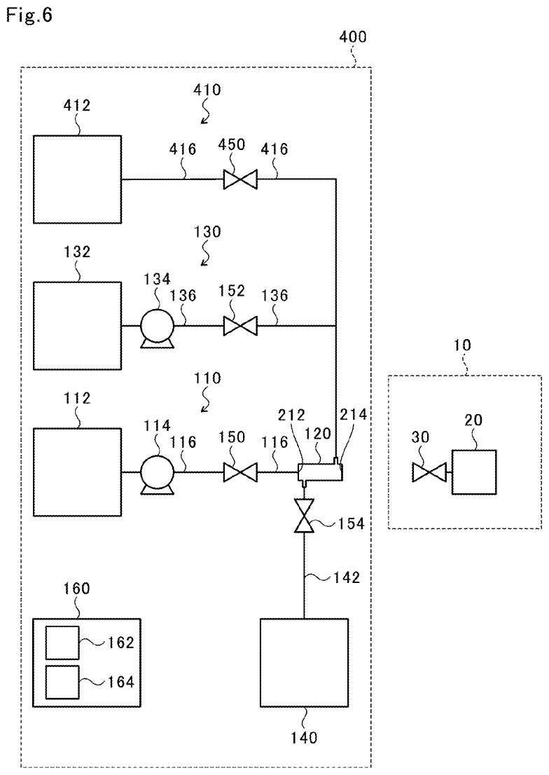

FIG. 6 is an explanatory view for illustrating an example of an ammonia supply device 400 according to a third embodiment. As illustrated in FIG. 6, the ammonia supply device 400 according to the third embodiment includes an ammonia supply system 110, a coupling 120, a water supply system 130, a drain tank 140, a first on-off valve 150, a second on-off valve 152, a third on-off valve 154, a controller 160, an inert gas supply system 410, and a fourth on-off valve 450. Components that are substantially equivalent to those of the ammonia supply device 100 described above are denoted by the same reference symbols, and description thereof is omitted.

The inert gas supply system 410 includes, for example, an inert gas cylinder 412 and an inert gas supply pipe 416. The inert gas cylinder 412 functions as an inert gas supply source. The inert gas cylinder 412 stores inert gas having a pressure higher than an atmospheric pressure. The inert gas is, for example, nitrogen. The inert gas supply pipe 416 connects the inert gas cylinder 412 to the water supply port 220 of the coupling 120. The inert gas supply pipe 416 is, for example, a flexible hose.

In the third embodiment, a two-fluid nozzle may be connected to the water supply port 220 of the coupling 120. The water supply pipe 136 may be connected to one supply port of the two-fluid nozzle, and the inert gas supply pipe 416 may be connected to another supply port of the two-fluid nozzle. When the two-fluid nozzle is connected, a fluid mixture of water and inert gas is sprayed into the tube body 210.

The fourth on-off valve 450 is provided in the inert gas supply pipe 416. The fourth on-off valve 450 opens and closes a flow passage formed in the inert gas supply pipe 416.

Further, in the water supplying process S126 of the ammonia supply method using the ammonia supply device 400 according to the third embodiment, the controller 160 supplies water and inert gas to the tube body 210 through the water supply port 220 of the coupling 120, and discharges water and inert gas from the tube body 210 through the drain port 230 of the coupling 120. In the water supplying process S126 in the third embodiment, the controller 160 opens the second on-off valve 152, the third on-off valve 154, and the fourth on-off valve 450, and operates the pump 134. Thus, water stored in the water tank 132 is supplied to the tube body 210 through the water supply pipe 136 and the water supply port 220 of the coupling 120, and inert gas stored in the inert gas cylinder 412 is supplied to the tube body 210 through the inert gas supply pipe 416 and the water supply port 220 of the coupling 120. The water and the inert gas are then discharged from the tube body 210 through the drain port 230 of the coupling 120, and discharged into the drain tank 140 through the drain pipe 142.

As described above, the ammonia supply device 400 according to the third embodiment includes the inert gas supply system 410, and the water supply port 220 of the coupling 120 is connected to the inert gas supply system 410 in addition to the water supply system 130. When water is supplied into the tube body 210 of the coupling 120, and ammonia in the tube body 210 dissolves in the water, the pressure in the tube body 210 decreases. Thus, the ammonia supply device 400 according to the third embodiment supplies inert gas, in addition to water, into the tube body 210 of the coupling 120, thereby being capable of suppressing the decrease in pressure in the tube body 210. As a result, the ammonia supply device 400 according to the third embodiment can prevent damage to the tube body 210 of the coupling 120 and members in communication with the tube body 210. The members in communication with the tube body 210 are, for example, the pump 134 and the water supply pipe 136 of the water supply system 130, the drain pipe 142, and the third on-off valve 154. Further, the ammonia supply device 400 according to the third embodiment can prevent the decrease in pressure in the tube body 210, and thus can prevent a backflow of wastewater from the drain pipe 142 to the tube body 210 through the drain port 230.

The embodiments have been described above with reference to the attached drawings, but, needless to say, the present disclosure is not limited to the above-mentioned embodiments. It is apparent that those skilled in the art may arrive at various alternations and modifications within the scope of the claims, and those examples are construed as naturally falling within the technical scope of the present disclosure.

For example, in the first embodiment described above, the case in which the drain port 230 is located vertically below the water supply port 220 under a state in which the second opening 214 of the coupling 120 is mounted to the ammonia consumption device 10 has been given as an example. However, under a state in which the second opening 214 of the coupling 120 is mounted to the ammonia consumption device 10, the drain port 230 may be located vertically above the water supply port 220, or the drain port 230 and the water supply port 220 may be located at the same vertical level.

Further, in the first to third embodiments described above, the case in which water is sprayed into the tube body 210 through the water supply port 220 has been given as an example. This allows ammonia to be easily dissolved in water, which enables the inside of the tube body 210 to be efficiently washed. However, there is no limitation to the mode of water supply through the water supply port 220. For example, water supplied from the water supply port 220 into the tube body 210 may be in the form of a jet, shower, or the like.

Further, in the first to third embodiments described above, the case in which the ammonia supply device 100, 300, 400 includes the drain tank 140 has been given as an example. However, the drain tank 140 may be omitted.

Further, in the first to third embodiments described above, the case in which the ammonia supply device 100, 300, 400 includes the water tank 132 as a water supply source has been given as an example. However, the water tank 132 and the pump 134 may be omitted. The water supply source may be, for example, a water pipe for drinking water. In this case, the water supply pipe 136 connects the water pipe to the water supply port 220 of the coupling 120.

Further, in the first to third embodiments described above, the case in which the ammonia supply device 100, 300, 400 is set up at an ammonia station has been given as an example. However, the ammonia supply device 100, 300, 400 may be installed in a tanker truck.

1. An ammonia supply device, comprising:
an ammonia supply source;
a coupling including:
a tube body having:
a first opening connected to the ammonia supply source; and
a second opening that is mountable to and detachable from an ammonia consumption device;
a water supply port formed between the first opening and the second opening in the tube body, and connected to a water supply source; and
a drain port formed between the first opening and the second opening in the tube body; and
an on-off valve that opens and closes the first opening.

2. The ammonia supply device according to claim 1, wherein the water supply port is connected to an inert gas supply source in addition to the water supply source.

3. The ammonia supply device according to claim 1, wherein the drain port is located vertically below the water supply port under a state in which the second opening is mounted to the ammonia consumption device.

4. The ammonia supply device according to claim 1, wherein a drain tank that stores water discharged from the tube body through the drain port is connected to the drain port.

5. An ammonia supply method, comprising:
mounting a coupling, which includes: a tube body having a first opening connected to an ammonia supply source, and having a second opening; a water supply port formed between the first opening and the second opening in the tube body, and connected to a water supply source; and a drain port formed between the first opening and the second opening in the tube body, so as to mount the second opening of the coupling to an ammonia consumption device;
supplying ammonia from the ammonia supply source to the ammonia consumption device through the coupling under a state in which the coupling is mounted to the ammonia consumption device;
closing an on-off valve that opens and closes the first opening after the supply of ammonia;
closing an on-off valve that opens and closes the second opening after the supply of ammonia;
supplying water to the tube body through the water supply port, and discharging water from the tube body through the drain port, under a state in which the on-off valve that opens and closes the first opening and the on-off valve that opens and closes the second opening are closed; and
detaching the second opening from the ammonia consumption device after the discharge of water.

6. The ammonia supply method according to claim 5, further comprising measuring a concentration of ammonia contained in the water discharged from the tube body through the drain port,
wherein the supply of water is stopped when the concentration of the ammonia becomes lower than a predetermined value.
